(19) United States
(12) Patent Application Publication
(10) Pub. No.: US 2009/0320125 A1
(43) Pub. Date: Dec. 24, 2009

(54) SYSTEMS, METHODS, AND COMPUTER READABLE MEDIA FOR COMPUTER SECURITY

(75) Inventors: James Carroll Pleasant, JR., Johnson City, TN (US); Dustin Lynn Dishner, Mount Carmel, TN (US)

Correspondence Address: WILLIAM K. MCGREEVEY;EASTMAN CHEMICAL COMPANY, 100 NORTH EASTMAN ROAD, KINGSPORT, TN, 37660-5075, US

(73) Assignee: EASTMAN CHEMICAL COMPANY, Kingsport, TN (US)

(21) Appl. No.: 12/437,841

(22) Filed: May 8, 2009

Related U.S. Application Data
(60) Provisional application No. 61/051,535, filed on May 8, 2008.

(51) Int. Cl. G06F 21/22; H04L 9/32

(52) U.S. Cl. 726/17; 726/19

(57) ABSTRACT

Embodiments of the present invention provide systems and methods that enhance the security various processes are provided, as well as machines, computer-readable media and processes that employ or allow employment of such systems.

### RELATED APPLICATIONS

This application claims the priority benefit of U.S. Provisional Pat. App. Ser. No. 61/051,535, titled “SYSTEMS, METHODS, AND COMPUTER READABLE MEDIA FOR COMPUTER SECURITY” filed May 8, 2008, the entire disclosure of which is incorporated herein by reference.

### FIELD OF THE INVENTION

The present invention relates to systems, methods and computer readable media for securing access to processes. Embodiments of the present invention provide systems and methods for controlling or restricting access to processes and process controls. The invention can be advantageous for use in computer systems operating and/or monitoring processes and/or data.

### BACKGROUND

Automated processes and systems for operating, controlling and/or monitoring processes have become widely used in a variety of fields, including, for example, industrial manufacturing and processing, power generation and distribution, information technology, telecommunications, medicine, financial services, transportation, shipping and the like. In these types of systems, input to a processor, such as a computer processor, may be provided through an input device, such as a keyboard, mouse, tablet, or touch screen, while output may also be provided, for example a display on a video monitor. An individual, or individuals, may wish to observe or monitor the output from the process being performed. It may also be desirable for one or more individuals to have access to the process allowing them to provide input that affect the process, for example if the information being monitored indicates or suggests that the operation/process should be stopped or modified, or if the individual desires to modify or to stop the operation/process for other reasons.

The adoption of process automation has led to growth in the complexity of automated process controls. Increasingly complex processes may require wider access to process control workstations, and yet a heightened need for security. It may be desirable to limit the rights access to the process, perhaps to a subset of the individuals who monitor the process. It may also be desirable to track individuals' use of access to the process. Where constant visibility into the process is desired, it may also be desirable to control access to the process using a method that does not interrupt the operation of the process or the output of data from the process.

Heightened security should not lead to delays in the access to process controls where urgently needed. For example, in some emergency situations, operators may need immediate access to a workstation to shut down an automated process. It may also be desirable for individuals without access to the process to have the ability to shut down the automated process.

### SUMMARY

Embodiments of the present invention provide systems and methods that enhance the security various processesO, as well as machines, computer-readable media and processes that employ or allow employment of such systems. A feature of some embodiments is that non-authenticated users may view information output by the computer, for example shown on a computer's display, but only authenticated users may interact with the processes running on the computer. Some embodiments of the invention may operate transparently, to allow visibility of the processes on the workstation, even when no users are logged on to the workstation. In some embodiments, even portion of the display (e.g. a screen or window) that is used to enter logon data is not visible unless there is some physical interaction with the input devices, such as typing a keyboard or moving a mouse, thus assuring that even the logon screen does not interfere with viewing the output from the process. An advantage of such embodiments is that a user can view or access the output of processes without being required to log on. A further advantage is that anyone in proximity to the output device (e.g., a computer monitor) can view or access the output of the processes but only certain users can log in and interact with the processes, thus enhancing security. Process automation control systems may have individual accounts or group accounts authorized to access computer workstations.

Embodiments of the present confer the advantages of security, emergency management, autonomy, and stability, along with other advantages. In particular, the systems of the present invention may be advantageously used to provide a system for authenticating operators and facilitating secure access to computer systems, including automated process control applications. Administrators may choose to allow onlookers to view the ongoing process in a read-only mode, even when no operator is logged in to that workstation.

Some embodiments of the invention act as a virtual filter between input devices, such as a keyboard and mouse, and one or more processes running on a computer. An advantage of such embodiments is security.

In some embodiments, the present invention enables operators to access process workstations quickly and securely through an authentication service running on each process control workstation. Through the present invention, access to these workstations is made more transparent for the individual, and other functionality follows.

According to some embodiments of the present invention, individual operators may be authenticated by a computer process active on each process control workstation. Some embodiments of the present invention involve a background process, or daemon, running on an operating system on a process control workstation. In such an embodiment, the background process may act as a controller for the process automation security system. For example, it may monitor the health of the system, stop and start other processes, and respond to requests from peer computers. In some embodiments, the background process does not interfere with individual process control applications. These embodiments may provide greater stability and control for the system.

### BRIEF DESCRIPTION OF THE DRAWINGS

These and other features, aspects, and advantages of the present invention are better understood when the following Detailed Description is read with reference to the accompanying drawings, which constitute part of this specification, wherein:

FIG. 1 is a flowchart illustrating the logical operations according to one embodiment of the invention when processing signals directed to a process.

FIG. 2 is a flowchart illustrating the logical operations according to one embodiment of the invention when processing signals directed to a security software related to obtaining access to one or more processes by transforming input devices to a state of having access to the process.

### DETAILED DESCRIPTION

Throughout this application, the terms such as “machine,” “process” and “input device” are used in both singular and plural for convenience. Regardless of how used, this invention and application are intended to cover embodiments in which such terms are singular, plural, or a combination thereof unless specifically stated otherwise (e.g. stating “only one,” a “plurality,” etc.).

Throughout this application various items such as machines, devices, networks are described as being “connected” to each other. The use of the terms “connection,” “connected,” etc. should not be interpreted as limiting the description to direct physical connections. Connections may be direct or indirect and through means other than physical connection (i.e. through other devices, wireless connections, other means that allow direct or indirect communication between the items, and combinations of the foregoing).

Embodiments of the present invention provide systems, methods, machines and computer readable media that allow for control of access to processes that are being performed on one or more machines, in some embodiments without interrupting the operation of the process or the output of data from that process. User authentication is provided as a means of controlling access to the process or processes. In some embodiments, this authentication occurs without interrupting the operation of the process or the output of data from the process, for example data output on a display or to monitor a process being performed.

In some embodiments, the invention provides software applications that operate as an input filter within the machine, for example, a filter between an operating system and one or more applications to which input is directed.

In some embodiments, user authentication data regarding a user is transmitted into a machine through a user's physical interaction with one or more input devices connected to a machine. An authentication determination is then made within the machine by comparing the user authentication data with one or more user authentication records within the machine, available to the machine, or both, to determine whether the user authentication data matches user authentication records for any person or group of persons. If the authentication determination indicates that the user authentication data input matches user authentication records for any person or group of persons, an access determination is made within the machine through the use of records regarding access rights regarding the person or group of persons within the machine, available to the machine, or both. Based on the outcome of the authentication determination, and, if made, the access determination, one or more input devices connected to the machine are transformed (or not transformed, if the conclusion is that the user is not authenticated or lacks access) to a state of having access the process. In some embodiments, all of these steps occur without the machine interrupting the process or interrupting output of data regarding the process.

In some embodiments, data is received that is directed to a process and transmitted into a machine through physical interaction with one or more first input devices connected to the machine. User authentication data regarding a user is also transmitted into the machine through physical interaction with one or more second input devices connected to the machine. An authentication determination is made within the machine regarding whether the user authentication data matches available user authentication records for any person or group of persons, by comparing the user authentication data with one or more user authentication records within the machine, available to the machine, or both. If the authentication determination indicates that the user authentication data matches user authentication records for a person or group of persons, an access determination is made within the machine through the use of records regarding access rights regarding the person or group of persons within the machine, available to the machine, or both. Based on the outcome of the authentication determination, and, if made, the access determination, the data directed to the process is or is not transmitted to the process. In some embodiments, all of these steps occur without the machine interrupting the process or interrupting output of data regarding the process.

The invention thus provides methods of controlling accesses to processes employing the techniques set forth in this application. The methods of the invention may be performed and single machines or groups of machines, including groups that perform the methods together or that separately perform the methods in parallel.

The invention also provides machines, groups of machines and systems having the features set forth in the present application, such as machines, groups of machines and systems having the means for performing these steps. The invention also provides software and computer readable media capable of performing the methods and techniques described herein.

The process controlled can be any type of process or group of processes. In some embodiments, all processes on a machine or group of machines are controlled. In some embodiments, access to one process or some processes on the machine or groups of machines is controlled, and access to one or more other processes on the machine or groups of machines is not. In some embodiments, the controlled process or processes is or includes one carried out on one or more mechanical devices, such as manufacturing devices, power or energy generating devices, devices performing industrial operations, transportation devices, medical or veterinary treatment devices, medical or veterinary diagnostic devices, analytical or measuring devices. In some embodiments, the process is carried out on electronic devices such as computers or data processing devices, for example a software program.

Accordingly, in some embodiments, the one or more machines that carry out the process or processes include one or more computers or data processors, such as one or more computers or data processors performing the process being controlled. In some embodiments, the one or more machines include one or more devices or articles of equipment performing the process, such as the mechanical devices discussed above. In such embodiments, the method can be performed directly on such machines or on a control machine configured to control the mechanical devices. Thus, in some embodiments, the process is operated on one or more machines and the input and determinations occur within one or more control machines (e.g. a computer, a data processor, or other control equipment) configured to control the process. In some embodiments, the process being controlled is operated on the machine in which the input and determinations occur.

Process control is achieved by regulating whether or not input devices (e.g. a keyboard and mouse) have access to the processes being controlled. Based on input from the user through physical interaction with input devices, determinations are made as to whether the user is an authenticated user with rights to access the process or processes. For authenticated users with access rights, input devices are transformed to a state of having access to the process or processes.

User access to the process is controlled through a determination of whether or not to allow input into the process. Any type of process input may be regulated by the method. Some examples include commands to start up or shut down one or more processes or portions thereof, commands to adjust process parameters (e.g. rate of feed of a fuel, feed or other material, speed, angle or direction of movement of a device or component, temperature, pressure, rate of feeding or pumping a control material such as a heat transfer fluid, parameters related to electronic operations, etc.), commands to monitor specific parameters or data points, commands to create certain setpoints for parameters or feedback loops between parameters, and comments to configure, disable, or stop process automation. In some embodiments, all commands are controlled because the access of all input from the devices to the process are controlled or limited.

Process input is made by any effective process input device. Some examples include a keyboard, a mouse, a tablet, a remote control or PDA, a touch screen, or a microphone. In some embodiments, such input devices generate input in response to physical interaction by the user (e.g. typing keystrokes, place a body part in front of or upon a scanner, speaking into a microphone, clicking a mouse, etc.).

Access is controlled by regulating the user's ability to provide input into the process and requiring authentication that the user has the requisite access rights as a prerequisite to providing input. In some embodiments, workstation input devices that are used to access the process (for example, a keyboard and mouse) will be locked out from access to the process (or processes) until a user having access rights is authenticated and the input devices are transformed to a state of access. In some embodiments, workstation input devices will have access to certain process (such as access authentication software logon purposes), but will be locked out of access to other processes until a user having access rights is authenticated. In some embodiments, workstation input devices that are used to access the process will function for certain purposes on the machine (for example, to input authentication data or to provide entry into an access control process only), but will be locked out of access to all other processes until a user having access rights is authenticated. In some embodiments, a workstation will allow use of input devices to provide entry directed to the process but will require a user having access rights to be authenticated before that input is actually transmitted to the process.

In some embodiments, the authentication and access control is a software application running as a background service, or daemon, on a computer operating system, such as the various versions of Microsoft Windows® (e.g. Windows 2000,Windows® 2000 Server, Windows® XP, Windows® 2003 Server, Windows Vista®, etc.), Apple Macintosh® systems (e.g. Mac OS and Mac OS X), MS-DOS® operating systems, UNIX, Unix-like systems and Unix variants such as System III, System V, Hewlett Packard UniX (HP-UX), Advanced Interactive executive (or AIX) Linux, Berkeley Software Distribution (BSD), or GNU. In some embodiments, the operating system is on a workstation upon which process control software is run. In some embodiments, the software application is configured to interface with the operating system at an interface where keystroke and mouse input to the operating system can be accessed, examined and filtered before being sent to application software. The software is configured to intercept or receive keystroke and mouse (and/or other input device) input from the operating system, and to regulate the preconditions under which it would to return or pass on such input along for transmittal to controlled programs. Access to such programs is controlled in this manner.

Any process that can be controlled on the machine or machines is within the scope of the inventions. In some embodiments in which the process is a software application, the process is a distributed control system (DCS) software. Some examples of DCS software include Westinghouse Distributed Processing Family (WDPF®), Ovation® and DeltaV, all available from Emerson Process Control Management; D/3®, available from NovaTech LLC; and TotalPlant® Solution (TPS), TDC and Experion® softwares, all available from Honeywell International Inc. In some embodiments, the process controlled is a financial services software, a data management center, a video surveillance system, a document creation process (such as a word processor, spreadsheet, or graphic design software) an electronic mail service, an accounting or financial service software, or internet browser. Combinations of any two or more of the foregoing are within the claimed invention. In some embodiments, access to all processes on the machine other than the security process of the invention are controlled.

Once the user is authenticated as having the requisite rights to the process, the invention may be configured to allow access to the process to continue for a desired duration after the entry or to end after a single entry or number of entries, requiring a reauthentication before further input will be allowed. If access is permitted to continue after the entry, the duration may be set in any suitable way. In some embodiments, access may continue until the authenticated user logs out of access to the process. In some embodiments, access may continue until another authentication attempt (successful or unsuccessful) is made. In some embodiments, process access may end after a predetermined period of inactivity after authentication (e.g. one minute, two minutes, five, 10, 15, 30 or 60 minutes, etc.). In some embodiments, process access may end after a predetermined period of time after authentication, irrespective of activity levels, (e.g. one minute, two minutes, five, 10, 15, 30 or 60 minutes, etc.), or at specific times of day (for example, changes in employee shifts). In some embodiments, process access may end after a predetermined number of inputs after authentication. Combinations of the foregoing endpoints or configurations providing these options in the alternative are also within the scope of the invention. In some embodiments, the invention may provide that users may log out of access to the process, for example by selecting a physical or virtual switch or button, or otherwise entering a command. In some embodiments, an existing logon of access to the process may end when another user is authenticated or attempts to be authenticated. Thus, in some embodiments of the invention, an operator can log into a workstation even though another operator is already logged in to the same workstation. The former operator will be automatically logged off before the new operator is given control of the workstation. Such embodiments may further enhance the accessibility and speed of the invention. Combinations of two or more of these features are also within the scope of the invention.

Authentication data is used to enable access to the process. Authentication data is input into a machine using input devices (which may be different from, or entirely or partially the same as, the input devices that are used for access to the process). The authentication data is compared to authentication records within or available to the machine. In some embodiments, the authentication records are stored electronically within the machine such as in a cached credentials file. In some embodiments, the authentication records are stored in a location accessible to the machine, for example on a network server accessible to the machine. In some embodiments, authentication information is first compared against records in the machine and, if no match is found, additional sources connected to or networked with the machine may be consulted for further information. An example is an alphanumeric user identification and alphanumeric password stored on a server that is accessible to the machine or machines. In some embodiments, the server is separated from the machine by a firewall, but the process and firewall are configured to allow access to the server for the purpose of access user authentication data. The results of the comparison with stored data are used by the machine to determine whether the user matches the identity of any persons or group of persons for whom authentication records are available.

The user authentication data may be any type of data that is useful for determining the identity of the user. Any effective type of authentication data may be used. In some embodiments, the authentication data may be one or more password, such as an alphanumeric password or a combination of an alphanumeric user identification code and a separate alphanumeric password. In some embodiments, the login process is structured in such a way that a user's password acts as an encryption string for the user's identity, which is stored on the computer. A feature of some embodiments is that a user's password is used to decrypt the user's identity as a means of user authentication. If the result of the decryption yields the user's identity, the password must be correct. If the decryption fails or yields a different user identity, the password is incorrect. In some embodiments, the authentication information may be data on a physical or electronic key device. In some embodiments, the authentication information may be biometric identification. Some examples of biometric identification include finger or thumbprint identification, iris recognition, retinal identification, geometry or appearance of one or more body parts such as the face or a hand, voice recognition, signature or handwriting recognition and blood vessel pattern recognition. In some embodiments, a single quick authentication, such as a fingerprint, may used, for example allowing a quick login to a workstation by touching a finger on the reader, rather than typing in an alphanumeric user ID and/or password. In some embodiments, two or more of the above options are available for user authentication, for example an embodiment in which the user has the option to enter an alphanumeric user identification and password or place a finger or thumb on a fingerprint reader. In some embodiments, the user must use two, three or more types of authentication data together. Some embodiments may require a user to authenticate by means of an alphanumeric user ID and password before registering fingerprint images. In some embodiments, the user must enter a password, swipe a keycard and then place finger or thumb on a fingerprint reader. Any of the foregoing options or combinations thereof, in the alternative or together, may be used.

The invention thus provides a variety of embodiments that may be selected to provide the desired balance between providing desired security and facilitating the speed and functionality of access. For example, if a particular biometric method such as fingerprint recognition is considered insufficiently reliable because only one fingerprint image per user is stored, it may be desirable to store multiple fingerprint images. Therefore, in some embodiments of the invention, users may have the ability to store one or more fingerprint images in order to ensure reliable recognition. Some embodiments of the invention may allow different fingers to be used for each image.

If the user is authenticated as a person a member of a group of persons for whom records are available, an access determination is then made within the machine regarding the access rights available to the user. The access determination is made based on information within or available to the machine regarding the access rights for the user or group. In some embodiments, the information is stored electronically within the machine. In some embodiments, the information is stored in a location accessible to the machine, for example on a network server accessible to the machine. In some embodiments, this is accomplished by checking for the existence of a flag, signal or other information signifying that the user or group is authorized.

In some embodiments, the authentication records and information regarding the access rights relate to one person, so that the determinations are both made on an individual by individual basis. One example of such an embodiment would be an authentication of an individual based on fingerprint image, and accessing a stored data flag identifying that individual's access rights. In some embodiments, the authentication records and information regarding the access rights relate to groups of persons, so that the determinations are both made based on the group to which the individual belongs. One example of such an embodiment would be authenticating group membership based on possession of a physical or electronic key assigned to a group and accessing a stored data flag identifying that group's access rights. In some embodiments, the authentication records relate to one person, and information regarding the access rights relate to a group. One example of such an embodiment would be authenticating the individual based on a fingerprint image, using the identity of the individual to determine group membership based on available group records, and accessing a stored data flag regarding the group to identify that group's access rights.

Based on the outcome from the authentication determination and the access determination, access rights to the user are either transformed to a state of access to the process (if the user is authenticated as a person or member of a group of persons having access rights to the process) or not transformed (if the user is not authenticated or is authenticated as a person or member of group of persons not having the requisite access rights to the process). Once the state of access is transformed, input from one or more input devices can provide input into the process. In some embodiments, data previously input directed to the process is transmitted to the process upon a successful grant of access (e.g. a log on).

In some embodiments, the access to a number of different processes on a machine are controlled and transformed. The method can be configured such that access to all such processes is controlled, or that access to some processes is controlled and access to others is not. In some embodiments, the method can be configured to control access to some parts of a process but to leave other parts of the process uncontrolled.

In some embodiments, access is a binary or “yes or no” question in which the user either receives complete access to a process or no access at all. In some embodiments, users can have different degrees of access, such that a user is granted access to parts of a process but not granted parts to others. It is thus possible to give different users different degrees of access to the process, for example by varying the access rights stored for each user and configuring the method to grant access based on those rights. Access to the process may be limited to a particular individual, or set of individuals, for example individuals having specific expertise relating to the underlying process. In some embodiments, the degree of access to the process to be granted to specific users may be configured to vary from user to user. Thus, the type of process access and input permitted may vary between users depending on the rights granted.

Input devices are used to enter input directed to the process as well as to enter authentication data. Any type of input device may be used. Some examples include a keyboard, a mouse, a tablet, a touch screen, or a microphone, a fingerprint reader, a scanner for biometric data (such as fingerprint and or thumbprints, retina, iris or geometry of one or more body parts) and electronic pad for signature or handwriting. In some embodiments, the user authentication data may be input using one or more devices that are different from the input device(s) used to provide process input. In some embodiments, the user authentication data may be input using the same one or more device(s) that are used to provide process input. In some embodiments, there is some overlap between the one or more device(s) used to input authentication data and the device(s) used to provide process input.

In some embodiments, the input of data and authentication determinations occur without interrupting the process or interrupting output by the control machine of data regarding the process. An example of such an embodiment is a process control system is a workstation that continues to allow processes such as process control applications, to continue to run when no users are logged in to the process control system. Some embodiments show the process control displays at all times. Such embodiments may keep the process transparent when no operator is logged in.

The invention may also optionally include a function to create a log of authentications and other actions performed in the method. In some embodiments, the function may log all authentication data entered, all authentication determinations made, all access determinations made, all transformations of input devices to enabled status, all expirations of terminations transformed status, or combinations of two or more of any of the foregoing. In some embodiments, the event log may log all user authentication and authorization activity. In some embodiments, the authentication and event logging provides record keeping. This may be useful, for example, if authentication is individualized under some embodiments in that multiple individual event logs for a workstation can be associated with different individual users or groups. If, for example, all transformations to and from access, along with the identity of the user, are logged, it will allow identification of which individuals or groups were accessing the process at a given time, such as when a particular process event occurred.

Some embodiments provide a method for viewing the logs. Thus, in some embodiments of the invention, one or more users (for example, system administrators) may have access to event logs, such as logs showing each event of transforming to and from enabled access. In such embodiments, a user may input commands in order to cause logs to be displayed on the screen or otherwise delivered as output.

Some embodiments may provide an emergency access feature, which may be a means of providing access to one or more processes without authentication where necessary. For example, the machine may include a button or switch associated with the machine, such as a physical switch or a virtual switch (e.g., a virtual “button” on a display that may be selected with a cursor) that, when activated will allow access to the process using the input devices without authentication. This feature can allow rapid access to the process where needed to avoid entering authentication data. In some embodiments, the emergency unlock access lasts for a finite period of time (e.g. one minute, two minutes, five, 10, 15, 30 or 60 minutes, etc.) before input devices are transformed back to no access. In some embodiments, the use of the emergency feature triggers an alarm event that can provide notification that the emergency feature has been used. Any type of alarm can be used including, for example, an audio alarm, a flashing light or other visual alarm, an electronic notification to one or more computer or email accounts, an email notification, or any combination of two or more of the foregoing. In some embodiments of the invention, the method or software is configurable. In such embodiments, some users (for example, system administrators) have the ability to set and change settings on the security module. Examples of such settings may include inactivity timeout (a duration of inactivity after which input devices are transformed back to no access), logon form timeout (a duration of inactivity on a log on window after which the logon form will become minimized or otherwise not visible until the next attempt to input data), duration of emergency unlock, logon form location on a display screen, emergency unlock enablement, authentication information and access information for authorized users, emergency unlock notification or alarm function, existence or membership operator group accounts, and identity of administrators, or disengaging or uninstalling software, including security software. In some embodiments administrators may, for example, access the workstation directly, or remotely, such as through a peer-to-peer network.

In some embodiments, the invention may provide autonomy for multiple automated processes. For example, some embodiments of the present invention may operate on a single machine or workstation without network access to other machines or workstations, such as a number of computer workstations connected in a peer-to-peer fashion, without a centralized server. This decentralized approach may be useful to facilitate autonomous functioning of each workstation. In some embodiments, multiple computers or workstations are connected via a centralized network or server.

In some embodiments of the invention, machines use network communication protocols (e.g. internet protocol sockets of “IP sockets”) to maintain synchronization. When an event occurs on one machine, that machine may use communication protocols to transmit a message to other machines that the event has occurred. After receiving this message, other machines may use network communication protocols to download data from the machine on which the event occurred. An advantage of such embodiments is that they enable the machines to remain synchronized with respect to information stored related to the method. Machines may thus synchronize even log information, authentication records, user access information, or combinations of two or more of the foregoing. In some embodiments of the invention, if one or more machines shuts down or otherwise go offline for a period of time the machine will, after rejoining the network or regaining connection with the other machines, contact other machine(s) to inform them that it is online, then use network communication protocols to synchronize its data with that of the other machine(s).

In some embodiments of the invention, an operator may log into one of many workstations using authentication data. The authenticated by then be conveyed to or shared with other workstations, for example by using standard Windows® domain authentication, cached credentials mode, or other authentication methods. One embodiment using cached credentials mode may have the advantage that if a connected network fails, the operator can still log in to the workstation.

In some embodiments, the invention operates in a networked environment. In some embodiments, one or more operators have the ability to log into more than one machine simultaneously. For example, in some embodiments, when an operator logs into a particular machine, that operator is automatically logged onto a group of machines. In some embodiments, one or more operators are automatically logged out of a group of machines when such operator logs out of one of the machines.

In some embodiments that allow a user to log into a group of machines simultaneously, the invention includes a method for determining the group of machines that the user has permission to access. Thus, embodiments of the invention may include methods for determining the group of machines that an operator has permission to access. In some embodiments, this feature can e set up such that when a particular operator logs into a machine, that operator will be logged into only the systems that the operator has permission to access.

In some embodiments, the invention may be configured such that an unauthenticated user does not provide input directed to the process until after authentication. In some embodiments, the invention may be configured to allow an unauthenticated user to enter data directed to the process, but the data is not transmitted to the process until after user authentication.

### Description of a System Using an Embodiment of the Invention

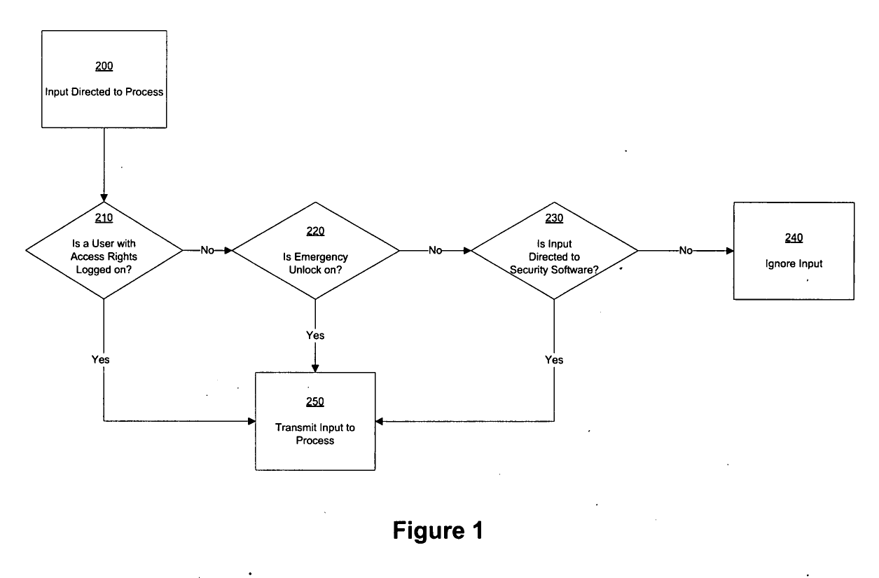

FIG. 1 is a flowchart illustrating the logical operations according to a security software application of one embodiment of the invention when processing signals directed to a process. Input 200 directed to the process is entered into the machine (not pictured) using one or more input devices (not pictured). In this embodiment, the security software receives the input 200 from an operating system (not pictured). The security software determines first determines (210) whether a user with access to the process is currently logged on (i.e. whether the input device has already been transformed to access status). If such a user is currently logged on, the security software transmits (250) the input to the process. If no such user is logged on, the security software determines (220) whether the emergency unlock is on (in which case the input device has already been transformed to access status). If the emergency unlock is on, the security software transmits (250) the input to the process. If the emergency unlock is not on, the security software determines (230) whether the input is directed to the security software itself. In this embodiment, the software is configured such that access to the security software itself is not controlled, meaning no transformation of access status is necessary. Therefore, if the input is directed to the security software itself, the security software transmits (250) the input. If the input is not directed to the security software itself, the security software ignores (240) the input and performs no further operation regarding the input.

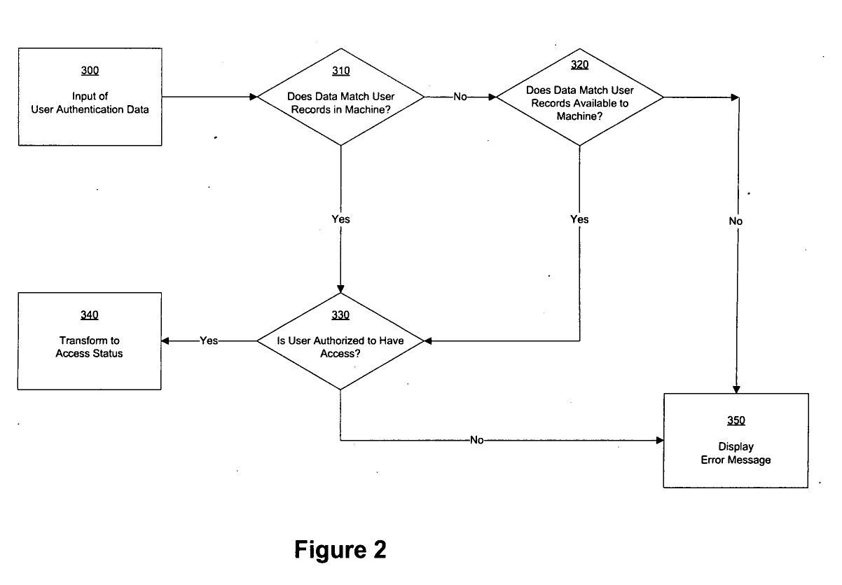

FIG. 2 is a flowchart illustrating the logical operations according to one embodiment of the invention when dealing with a logon attempt in a security software to gain access to one or more processes. Input 300 of user authentication data is entered into the machine (not pictured) using one or more input devices (not pictured). In this embodiment, the security software receives the input 300 from an operating system (not pictured). The security software determines (310) whether the input data matches user records in the machine. If the input data does not match user records in the machine, the security software accesses other user records available to the machine (for example on a company network) and determines (320) whether the data matches any of those records. If the input data does not match any user records in or available to the machine, the software displays an error message (350) and the logon is terminated. However, if the input data does match user records in or available to the machine, the security software determines (330) whether the now-identified user has access through use of access records regarding the user. If the records indicate that the now-identified user has access rights, the security software transforms (340) the access status of the input devices to grant access to other processes on the computer. If the records indicate that the now-identified user does not have access, the software displays an error message (350) and the logon is terminated. In this particular embodiment, the result of the logon process is described as a binary “all or nothing” grant or denial of access rights to processes on the machine. In some embodiments, however, access may be limited only to certain processes or certain subsets of rights regarding processes on the machine.

### Illustrative Application of Embodiments of the Invention to Specific Environments

The invention has broad applicability to a variety of processes carried out on machines. Any process to which the invention applies is within the scope of the invention.

In some embodiments, the controlled process may be a manufacturing process or a process associated with research or scientific activities. Some examples of such processes include chemical reaction processes, biological or biochemical reaction processes, surface treatment processes (e.g. coating, cleaning, washing, etching, engraving, or staining), chemical treatment processes, assembly processes, temperature treatment processes (e.g. autoclaves, thermal reactors, cooling or quenching processes, dryers, calciners, kilns and other heaters or chillers), storage and/or material handling processes, transportation processes, metallurgical processes, packaging processes, cutting, machining, shaping or milling processes. Many such processes are controlled by automated control systems, such as a DCS software. For example, some embodiments of the present invention are advantageously used with process automation workstations used in the production of products, such as the production of chemicals. Examples of such programs include workstations used for distributed control systems.

In some embodiments, the controlled process may be a process associated with medical or veterinary treatment, monitoring or diagnosis. Some examples include automated administration of medical treatments (e.g. surgery or preparatory steps for surgery, anesthesia, medication, radiation treatments, physical therapy, etc.), automated diagnostic equipment (e.g. body function measurement or monitoring, radiology or ultrasound, analysis of tissues or bodily fluids etc.) automated administration of nutrition (e.g., feeding tubes, intravenous administration etc.), pacemakers and breathing apparatus, and other health and medical processes and equipment. In some embodiments the invention provides the ability for anyone to monitor (e.g. via a display monitor in a computer workstation in a nursing station or control room in a hospital environment) data output from treatment or diagnostic equipment, but control and limit access to modify the operations to certain specified personnel. An advantage of using some embodiments of the invention in this context may include the ability for all personnel to view status information, but for certain privileged users to have the ability to log into the system and make modifications. In some embodiments, different classes of users may have different degrees of access to processes.

In some embodiments, the controlled process may be a power, energy and/or steam generating process environment, including but not limited to process using nuclear, fossil fuel, bioenergy, solar energy, wind, geothermal, hydroelectric energy, or any combinations thereof. The invention can allow personnel to monitor parameters associated with the process only but not to control the process without proper authentication and rights. In some embodiments, certain personnel can have limited access to rights to startup, shutdown, or control the process. In some embodiments, for example, some personnel would receive the rights only to conduct an emergency shutdown while other personnel with greater rights of access have the rights to conduct other operations such as startup the process or modify process parameters on the ongoing process. A further advantage may include the ability to obtain access to the computer while continuing to view the information displayed on the screen regarding the components of the power plant.

In some embodiments, the controlled process may be telecommunications systems. In some embodiments, for example, it may be advantageous to allow monitoring of an output of transmission data without authentication, but only allow authenticated individuals with appropriate access to modify settings such as transmission routing.

In some embodiments, the controlled process may be a financial services process, such as a process for routing data among financial institutions. In some embodiments, for example, it may be advantageous to allow monitoring of process to continue without authentication and access, but only allow authenticated individuals with appropriate access to make changes such as, for example a currency exchange rate.

In some embodiments, the controlled process may be a process associated with transportation. Some examples include air traffic control processes, rail traffic control processes, Vessel Traffic Services for water vessels, and traffic control processes for automobiles, trucks, buses and/or construction equipment. In some embodiments, output data such as traffic data may be monitored continuously, but only authenticated personnel with the appropriate level of rights can alter traffic patterns or instructions to vehicles in traffic.

In some embodiments, the controlled process may be a physical surveillance system. For example, function output of the surveillance system (camera images) may continue to be accessible without access to the process, but authentication and access is required to alter the process, for example by repositioning a camera. Advantages of using some embodiments of the invention in physical surveillance systems may include the ability for multiple operators to view multiple screens. A further advantage may include the ability to log into the computer while continuing to view the information displayed on the screen. A further advantage may include the ability for one operator to log into multiple systems simultaneously so that the operator can perform operations on multiple systems without being required to separately log into each one.

In some embodiments, the controlled process or processes may be one or more data center management systems. Advantages of using the invention in data center management systems may include the ability for multiple operators to view multiple screens. A further advantage may include the ability to log into a computer while continuing to view the information displayed on the screen. A further advantage may include the ability for one operator to log into multiple systems simultaneously so that the operator can perform operations on multiple systems without being required to separately log into each one.

A further application of some embodiments of the invention may include providing access control for kiosk displays. Examples of kiosk displays include lookup terminals in retail and warehouse stores and advertisement screens in retail and public areas. Advantages of using the invention in kiosk display systems may include the ability for non-privileged persons, who may include members of the general public, to view the screen. A further advantage may include the ability for a privileged user to log into a computer while the information continues to be displayed on the screen.

A further application of some embodiments of the invention may include providing access control for video conferencing systems. Advantages of using the invention in video conferencing systems may include the ability for the participants in the video conference to view the screen while limiting access to programs controlling video equipment and information displayed on the equipment.

The examples herein are not intended to be limiting, and any uses of the systems are within the scope of the invention. As will be appreciated, the foregoing provides an overview of the features of some of the illustrative embodiments of the present invention and should not be read as limiting. The present invention is capable of multiple advantageous uses as a replacement for current process automation technology, and for uses not capable of being handled by current process automation technology.

The foregoing description of the embodiments of the invention has been presented only for the purpose of illustration and description and is not intended to be exhaustive or to limit the invention to the precise forms described. Numerous modifications and adaptations are apparent to those skilled in the art without departing from the scope of the invention.

### EXAMPLE 1

Operating parameters for a chemical manufacturing process performed on a number of machines were controlled using Ovation®, a distributed control system (DCS) software available from Emerson Process Control Management, which operated on a DCS Console computer configured with the Windows® XP operating system. A security software program of the present invention was uploaded into the DCS Console. The security software program was written such that it would interface with the operating system in the control machine at an interface (in this case SetWindowsHookEX) where keystroke and mouse input to the operating system can be examined and filtered before being sent to various applications and software programs.

The security software program had been configured with a security module similar to that described by FIG. 1 such that it would intercept keystroke and mouse input, but would not pass it on to applications software programs unless at least one of the following preconditions was satisfied: (a) a user having rights to provide such input was logged onto the security software program; or (b) an emergency access function had been enabled on the security software program; or (c) the keystroke and/or mouse input was directed to the security software program itself. Option (c) was in place to assure that users could actually provide input into the security software program. The result of this software configuration was that mouse and keyboard access was disabled for all programs other than the security program except during a successful logon or emergency access function. If any of these conditions were met, however, the mouse and keyboard input was permitted to access all programs on the computer, including the DCS program. However, the actual operation of the DCS program as well as the monitor display of output from the DCS program were uninterrupted.

Although input to the security software was permitted, this input was limited to attempts to logon, logoff, or trigger emergency mode for most users. Additional functions such as configuring the security software could be performed only when a user having administrator rights is logged into the security software.

The security software displayed a small window in the corner of the display monitor on the computer. The window was large enough to be readable and to allow input into the security software program, but small enough that it did not interfere with viewing of the output. The window included a display of the status of the security software program (e.g. identity of any person who is logged in, waiting for someone to log in, emergency unlock mode, error message), buttons and fields for input of logon information (e.g. entry of an alphanumeric User ID and Password, a button for submitting the information in the fields, a button to activate registration and configuration function for users such as fingerprint registration, emergency unlock request, hide the window, show help documentation), and a button for triggering emergency access mode.

The software contained a login process similar to that described in FIG. 2. User credentials and information regarding user access rights (including whether such users have rights as well as the extent of such rights) were cached within the computer. The user credentials include alphanumeric user identifications and passwords as well as previously registered fingerprints from one or more finger or thumb. The workstation was configured with a fingerprint reader for both initial registration of fingerprint information and scanning for use. A user having access rights could logon to a workstation by either entering their user ID and password or placing the appropriate finger or thumb on the reader.

The user ID and password were the same that are used to grant the user access to a corporate information systems network, where the user had rights to perform other functions such as electronic mail, word processing, internet access, but could connect to the DCS software. The computer containing the DCS software was separated from the corporate network by a firewall such that the user could not logon to the corporate network from that computer. Upon receiving the logon attempt, the security software would attempt to authenticate the user by comparing the logon information with cached credential information. If no match is found and the logon information is a user ID and password, the security software will cross the firewall for the limited purpose of verify that the cached user ID and password information is current, and updated the information if it does not. If no match is still found, the logon attempt terminates and an error message displays on the window for the software. If a match is found (i.e. the user is authenticated), the security software then accesses cached records regarding the access rights associated with the credentials. If those records indicate that the authenticated user has access rights, access will be granted. If those records indicate that the authenticated user does not have access rights, the logon attempt terminates and an error message displays on the window for the software. However, the computer has limited access across the firewall for the purpose of accessing and updating user ID and password information. Thus, for example, whenever there had been a change to the user's password on the corporate network, the user's next login attempt using the new password would not match authentication records within the machine, but the machine would access the updated corporate network password across a firewall and update its records accordingly.

The emergency access mode was triggered by double clicking the appropriate button on the window. When triggered, it remains open for a set period of time (e.g. 15 minutes). The software was also configured with an alarm function that sends an email to a system administrator whenever the emergency access mode was triggered. The email was sent using an email software on the corporate network, and the firewall separating the workstations from the network was configured to allow the software to cross the firewall for the purpose of accessing the email and sending the message.

### EXAMPLE 2

A plurality of computers programmed with the DCS software and the security software of EXAMPLE 1 are installed as workstations in a control room for a manufacturing process. The computers are connected via peer-to-peer connections. The security software causes the workstations synchronize data with each other via IP sockets at selected intervals. The software shares information such as authentication credentials and system configuration data (e.g., list of authorized users, timing parameters, communications settings, etc.) between the different workstations.

1. A method for controlling user access to a process being executed on a machine while the machine is outputting data regarding the process, the method comprising:
receiving user authentication data regarding a user transmitted into the machine through physical interaction with one or more first input devices connected to the machine;
making an authentication determination within the machine regarding whether the user authentication data matches available user authentication records for any person or group of persons, wherein making the authentication determination comprises comparing the user authentication data with one or more user authentication records within the machine, available to the machine, or both;
if the authentication determination indicates that the user authentication data matches user authentication records for a person or group of persons, making an access determination within the machine, wherein the access determination comprises use of records regarding access rights regarding the person or group of persons within the machine, available to the machine, or both;
based on the outcome of the authentication determination, and, if made, the access determination, transforming or not transforming one or more second input devices connected to the machine such that such second input devices have access to the process.

2. The method of claim 1, wherein receiving the user authentication data, making the authentication determination, making the access determination, and transforming or not transforming one or more second input devices occur without interrupting the operation of the process or interrupting output of data regarding the process.

3. The method of claim 2, wherein the output of data regarding the process is viewable on a display device.

4. The method of claim 1, wherein at least one of the one or more first input devices comprises at least one of the one or more second input devices.

5. The method of claim 1, wherein the one or more first input devices are different devices from the one or more second input devices.

6. The method of claim 1, wherein the process is selected from financial services software, data management software, a video surveillance system, a document creation software application, an electronic mail service, an accounting or financial service software, or internet browser and a distributed control system software.

7. The method of claim 1, wherein the process is a distributed control system software.

8. The method of claim 1, wherein the authentication data comprises information selected from alphanumeric passwords, alphanumeric user identifications, data stored on one or more physical key devices, data stored on one or more electronic key devices, images of one or more fingerprints or thumbprints, images of an iris of one or more eye, images of one or more retina, images showing blood vessel patterns of one or more body parts, images of a geometry or appearance of one or more body parts, voice samples, signatures, handwriting samples, and combinations of two or more of the foregoing.

9. The method of claim 1, wherein the authentication data comprises information selected from alphanumeric passwords, alphanumeric user identifications, images of one or more fingerprints or thumbprints, and combinations of two or more of the foregoing.

10. The method of claim 1 wherein the method further comprises generating an event log recording information selected from all authentication data entered, all authentication determinations made, all access determinations made, all transformations of input devices to enabled status, all expirations of terminations transformed status, and combinations of two or more of any of the foregoing.

11. The method of claim 1, wherein the machine is a computer.

12. The method of claim 1, wherein;
the user authentication data is data identifying the user as an individual person rather than a member of a group;
the authentication records and the records regarding the access rights relate to individual persons rather than groups;
the authentication determination and the access determination relate to an individual person rather than a group.

13. The method of claim 1 further comprising:
receiving an emergency unlock request as a result of physical interaction with one or more first input devices; and
in response to the emergency unlock data input, transforming one or more second input devices connected to the machine such that such second input devices have access to the process.

14. The method of claim 13, further comprising:
receiving input directed to the process from the one or more second input devices;
making a determination as to whether the one or more second input devices have access to the process;
if the one or more second input devices are enabled to access the process, transmitting the input directed to the process to the process;
if the one or more second input devices are not enabled to access the process, making a determination of whether the emergency unlock function is activated;
if the emergency unlock function is activated, transmitting the input directed to the process to the process;
if the emergency unlock function is not activated, making a determination of whether the process is a software application that performs the method;
if the process is a software application that performs the method, transmitting the input directed to the process to the process;
if the one or more second input devices are not enabled to access the process, and the emergency unlock function is not activated, and the input is not directed to the process is a software application that performs the method, displaying an error message and declining to transmit the input directed to the process to the process.

15. A method for controlling access to process controls for a process being executed on one or more process machines wherein the control machine is connecting to the one or more process machines in a manner that will allow the control machine to control the one or more process machines and wherein the control machine is outputting data regarding the process, the method comprising:
receiving user authentication data regarding a user transmitted into a control machine through physical interaction with one or more first input devices connected to the control machine;
making an authentication determination within the control machine regarding whether the user authentication data matches available user authentication records for any person or group of persons, wherein making the authentication determination comprises comparing the user authentication data with one or more user authentication records within the control machine, available to the control machine, or both;
if the authentication determination indicates that the user authentication data matches user authentication records for a person or group of persons, making an access determination within the control machine, wherein the access determination comprises use of records regarding access rights regarding the person or group of persons within the control machine, available to the control machine, or both;
based on the outcome of the authentication determination, and, if made, the access determination, transforming or not transforming one or more second input devices connected to the control machine such that such second input devices have access to the process.

16. The method of claim 15, wherein receiving the user authentication data, making the authentication determination, making the access determination, and transforming or not transforming one or more second input devices occur without interrupting the operation of the process or interrupting output of data regarding the process.

17 The method of claim 15, wherein the control machine is a computer.

18. A machine or group of machines comprising:
means to operate a process on the machine or group of machines;
means to receive user authentication data regarding a user transmitted into the machine or group of machines through physical interaction with one or more first input devices connected to the machine or group of machines;
means to make an authentication determination within the machine or group of machines whether the user authentication data matches available user authentication records for any person or group of persons, wherein making the authentication determination comprises comparing the user authentication data with one or more user authentication records within the machine or group of machines, available to the machine or group of machines, or both;
means to make an access determination within the machine or group of machines, if the authentication determination indicates that the user authentication data matches user authentication records for a person or group of persons, wherein the access determination comprises use of records regarding access rights regarding the person or group of persons within the machine or group of machines, available to the machine or group of machines, or both;
means to enable or not enable the one or more second input devices connected to the machine or group of machines to access the process, based on the outcome of the authentication determination.

19. The machine or group of machines of claim 18, further comprising the means to receive the user authentication data, to make the authentication determination, to make the access determination, and to transform or not transform one or more second input devices without interrupting the operation of the process or interrupting output of data regarding the process.

20. The machine or group of machines of claim 19, wherein the output of data regarding the process is viewable on a display device.

21. The machine or group of machines of claim 18 wherein the method further comprises a means to generate an event log recording information selected from all authentication data entered, all authentication determinations made, all access determinations made, all transformations of input devices to enabled status, all expirations of terminations transformed status, and combinations of two or more of any of the foregoing.

22. The machine or group of machines of claim 18, wherein the machine is a computer.

23. The machine or group of machines of claim 18, wherein;
the user authentication data is data identifying the user as an individual person rather than a member of a group;
the authentication records and the records regarding access rights relate to individual persons rather than groups; and
the authentication determination and the access determination relate to an individual person rather than a group.

24. The machine or group of machines of claim 18 further comprising:
means to receive an emergency unlock request input as a result of physical interaction with one or more first input devices; and
in response to the emergency unlock data input, means to transform one or more second input devices connected to the machine such that such second input devices have access to the process.

25. The machine or group of machines of claim 24, further comprising,
means to receive input directed to the process from the one or more second input devices;
means to make a determination as to whether the one or more second input devices have access to the process;
means to transmit the input directed to the process to the process if the one or more second input devices are enabled to access the process;
means make a determination of whether the emergency unlock function is activated if the one or more second input devices are not enabled to access the process;
means to transmit the input directed to the process to the process if the emergency unlock function is activated;
means to make a determination of whether the process is a software application that performs the method if the emergency unlock function is not activated;
means to transmit the input directed to the process to the process if the process is a software application that performs the method;
means to display an error message and to decline to transmit the input direct to the process the process if the one or more second input devices are not enabled to access the process, and the emergency unlock function is not activated, and the input is not directed to the process is a software application that performs the method.

26. A method for controlling user access to a process being executed on a machine while the machine is outputting data regarding the process, the method comprising:
receiving data directed to the process transmitted into the machine through physical interaction with one or more first input devices connected to the machine;
receiving user authentication data regarding a user transmitted into the machine through physical interaction with one or more second input devices connected to the machine;
making an authentication determination within the machine regarding whether the user authentication data matches available user authentication records for any person or group of persons, wherein making the authentication determination comprises comparing the user authentication data with one or more user authentication records within the machine, available to the machine, or both;
if the authentication determination indicates that the user authentication data matches user authentication records for a person or group of persons, making an access determination within the machine, wherein the access determination comprises use of records regarding access rights regarding the person or group of persons within the machine, available to the machine, or both;
based on the outcome of the authentication determination, and, if made, the access determination, transmitting or not transmitting the data directed to the process to the process.

27. The method of claim 26 wherein the method further comprises, depending the outcome of the authentication determination, and, if made, the access determination, transforming or not transforming one or more second input devices connected to the machine such that such second input devices have access to the process.

28. The method of claim 27, wherein receiving data directed to the process, receiving the user authentication data, making the authentication determination, making the access determination, and transforming or not transforming one or more second input devices occur without interrupting the operation of the process or interrupting output of data regarding the process.

29. Computer readable media capable of performing the method of claim 1.

30. A computer system performing the method of claim 1.
